(19) United States
(12) Patent Application Publication
(10) Pub. No.: US 2026/0044571 A1
(43) Pub. Date: Feb. 12, 2026

(54) INFORMATION PROCESSING APPARATUS

(71) Applicant: TOYOTA JIDOSHA KABUSHIKI KAISHA, Toyota-shi (JP)

(72) Inventor: Yu NAGATA, Tokyo-to (JP)

(73) Assignee: TOYOTA JIDOSHA KABUSHIKI KAISHA, Toyota-shi (JP)

(21) Appl. No.: 19/268,447

(22) Filed: Jul. 14, 2025

(30) Foreign Application Priority Data
Aug. 9, 2024 (JP) 2024-133901

(51) Int. Cl. G06F 16/958; G10L 13/02; H04L 67/02

(52) U.S. Cl. CPC G06F 16/958; G10L 13/02; H04L 67/02

(57) ABSTRACT

A controller of an information processing apparatus accesses a web page on which a notification information that is an information to be notified to a user of a vehicle is posted, and obtains a latest update and time of the notification information posted on the web page. The controller transmits, in response to the update date and time being after a predetermined date and time, a first command to output a first voice data that is a voice data according to the notification information to the terminal of the vehicle. The controller transmits, in response to determining that the update date and time is earlier than the predetermined date and time, a second command to output a second voice data that is a voice data according to the notification information and that is shorter than the first voice data to the terminal.

### CROSS REFERENCE TO THE RELATED APPLICATION

This application claims the benefit of Japanese Patent Application No. 2024-133901, filed on Aug. 9, 2024, which is hereby incorporated by reference herein in its entirety.

### BACKGROUND

### Technical Field

The present disclosure relates to an information processing apparatus.

### Description of the Related Art

A technology is known in which information is a plurality classified into of predetermined display patterns according to the values of at least two of three parameters, namely, the relationship with driving, the importance to the user, and the immediacy of the display, and information is displayed in the classified display mode (for example, Patent Literature 1).

### CITATION LIST

### Patent Literature

Patent Literature 1: International Publication No. 2015/159340

### SUMMARY

An object of the present disclosure is to provide a technique that is effective in improving user convenience when providing information to a vehicle user.

One aspect of the present disclosure may be an information processing apparatus comprising a controller configured to execute processing of:
obtaining a HTTP (Hyper Text Transfer Protocol) response by accessing a web page on which a notification information that is an information to be notified to a user of a vehicle is posted;
identifying a latest update date and time of the notification information according to a Last-Modified included in a header of the HTTP response;
determining whether the identified update date and time is on or after a predetermined date and time;
in a case where it is determined that the update date and time is on or after the predetermined date and time, generating a first voice data including a voice data obtained by converting the notification information posted on the web page using an existing voice synthesis process and predetermined voice data, and transmitting a first command signal to output the first voice date to a terminal mounted on the vehicle; and
in a case where it is determined that the update date and time is earlier than the predetermined date and time, generating a second voice data including only the voice data obtained by converting the notification information posted on the web page using the existing voice synthesis process, and transmitting a second command signal to output the second voice data to the terminal.

Another aspect of the present disclosure may be an information processing apparatus comprising a controller configured to execute processing of:
accessing a web page on which a notification information that is an information to be notified to a user of a vehicle is posted;
obtaining a latest update date and time of the notification information posted on the web page;
determining whether the obtained update date and time is on or after a predetermined date and time;
in a case where it is determined that the update date and time is on or after the predetermined date and time, transmitting a first command to output a first voice data that is a voice data according to the notification information posted on the web page to a terminal mounted on the vehicle; and
in a case where it is determined that the update date and time is earlier than the predetermined date and time, transmitting a second command to output a second voice data that is a voice data according to the notification information posted on the web page and that is having a shorter sentence than the first voice data to the terminal.

Further, other aspect of the present disclosure may be an information processing method, program for causing a computer to execute the above-described information processing method, or a computer-readable storage medium non-temporarily storing the program.

According to the present disclosure, it is possible to provide a technique that is effective in improving user convenience when providing information to a vehicle user.

### BRIEF DESCRIPTION OF THE DRAWINGS

FIG. 1 is a diagram illustrating an example of a system according to an embodiment.

FIG. 2 is a diagram illustrating an example of information stored in a road DB according to the embodiment.

FIG. 3 is a diagram illustrating an example of information stored in a charging facility DB according to the embodiment.

FIG. 4 is a flowchart illustrating an example of a first processing routine executed by a server according to the embodiment.

FIG. 5 is a flowchart illustrating an example of a second processing routine executed by the server according to the embodiment.

### DESCRIPTION OF THE EMBODIMENTS

One possible service is to inform users of vehicles of information such as road construction information or charging facility information. However, if information with newer update dates and information with older update dates are notified to users in the same manner, users may not be able to distinguish between the two pieces of information, which may result in reduced convenience for the user. Therefore, there is a need for a way to improve the convenience of the above-mentioned services for users.

In response to this, an information processing apparatus according to the present disclosure notifies a user of a vehicle of information with newer update dates and information with older update dates in different manners. In one example, the information processing apparatus according to the present disclosure may be a server connected to a terminal mounted in a vehicle via a communication network. The terminal mounted on the vehicle is a terminal in which an application program for car navigation is installed. Such a terminal may be a terminal provided in the vehicle or may be a terminal carried by the user of the vehicle.

In the information processing apparatus according to the present disclosure, the controller accesses a web page on which a notification information that is an information to be notified to the user is posted, and obtain a latest update date and time of the notification information posted on the web page. The notification information may be, for example, a road construction information, or a vacancy information regarding a vacancy status of a charging facilities for a vehicle battery. As an example, the latest update date and time of the notification information can obtain by obtaining Last-Modified, which is included in the header of the HTTP response transmitted from a web server to the information processing apparatus in response to an HTTP request transmitted from information processing the apparatus to the web server (the web server that provides the web page).

The controller of the information processing apparatus according to the present disclosure determines, in response to obtaining the latest update date and time of the notification information, whether the update date and time is on or after a predetermined date and time. The predetermined date and time may be changed as appropriate depending on the type of the notification information. As an example, when the notification information is an information whose situation is unlikely to change in a short period of time, such as a road construction information, the specified date and time may be a date and time several hours or one day before the present time. As another example, when the notification information is an information whose situation is likely to change in a short period of time, such as a vacancy information of a charging facility, the predetermined date and time may be a date and time several tens of minutes or one hour before the current time.

If it is determined that the update date and time is on or after the predetermined date and time, the controller of the information processing apparatus according to the present disclosure transmit a first command to the terminal mounted in the vehicle to output first voice data that is a voice data according to the notification information posted on the web page. In one example, the first voice data may include a predetermined voice data in addition to a voice data generated by synthesizing a text of the notification information posted on the web page using existing technology (e.g., Large Language Models (LLM) and Text Speech (TTS)).

If it is determined that the update date and time is earlier than the date predetermined and time, the controller of the information processing apparatus according to the present disclosure transmit a second command to the terminal to output a second voice data that is a voice data according to the notification information posted on the web page and that is shorter than the first voice data. In one example, the second voice data may include only a voice data generated by voice synthesizing the notification information posted on the web page using existing technology, and may not include the above-mentioned predetermined voice data.

Here, the above-mentioned predetermined voice data may be, for example, a voice data that prompts the user to operate a GUI (Graphical User Interface) component that is displayed on a screen when the terminal of the vehicle outputs (plays back) the first voice data. In this case, the GUI component may be, for example, an icon (such as a banner) including a link information of the web page on which the notification information is posted. When such predetermined voice data is included in the first voice data, the first command may include, in addition to a command to output the first voice data, a command to output (display on screen) the above-mentioned GUI component. The predetermined voice data may be an information accompanying the notification information (e.g., an information regarding traffic congestion due to the road construction or an information regarding a number of vehicles waiting to be charged at the charging facility) converted into voice data.

The timing at which the first voice data or the second voice data in the present disclosure is output to the terminal of the vehicle may be changed as appropriate depending on the type of the notification information. In one example, when the notification information is the road construction information, the first voice data or the second voice data may be output at the timing when a scheduled travel route is set on the terminal of the vehicle. As another example, when the notification information is the vacancy information of the charging facility, the first voice data or the second voice data may be output at a timing when a predetermined condition is satisfied. The predetermined conditions may include that the distance between the current location of the vehicle and the charging facility is not longer than a predetermined distance, and that the remaining battery charge of the vehicle is not larger than a threshold.

According to the present disclosure, it is possible to notify the user of information with newer update date and time and older update date and time using different voices. This allows the user to distinguish between information with newer update date and time and information with older update date and time. Furthermore, information with older update date and time is notified by voice data with shorter sentences than information with newer update date and time. This can also reduce the inconvenience felt by the user. Furthermore, by notifying user of the notification information by voice, it is possible to prevent the user from staring at the display screen of the in-vehicle apparatus while driving. This improves the convenience for the user when providing information to the user of the vehicle.

Hereinafter, specific embodiments of the present disclosure will be described with reference to the drawings. Unless otherwise specified, the hardware configuration, module configuration, functional configuration, and the like described in the following embodiment are not intended to limit the technical scope of the present disclosure to only those.

### EMBODIMENT

In this embodiment, an example will be described in which the information processing apparatus according to the present disclosure is applied to a system for notifying users of vehicles of road construction information and vacancy information of charging facilities.

### (System Configuration)

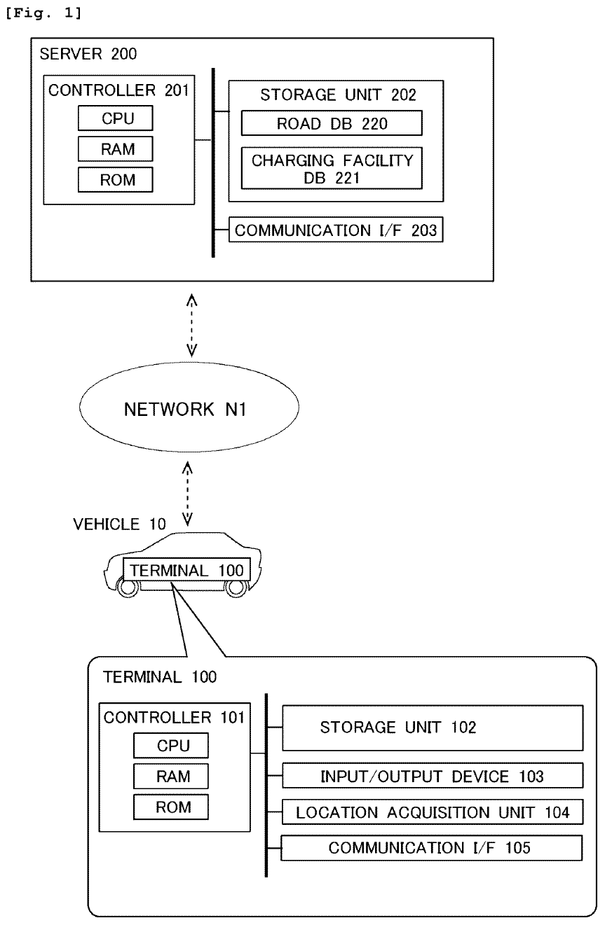

FIG. 1 is a diagram illustrating an example of the configuration of the system according to present embodiment. In the illustrated example of FIG. 1, the system 1 includes a terminal 100 and a server 200. In the illustrated example of FIG. 1, only one terminal 100 is illustrated, but multiple terminals 100 may be included in the system 1. The terminal 100 and the server 200 are connected to each other via a communication network N1. The communication network N1 may, for example, include a WAN (Wide Area Network), which is a global public communication network such as the Internet, and/or a wireless communication network such as Wi-Fi (registered trademark).

### (Terminal 100)

The terminal 100 is configured as a computer having a processor (such as a CPU or GPU), a main memory (such as a RAM and ROM), and an auxiliary memory (such as an EPROM, a hard disk drive, and a removable media), and is installed in the vehicle 10. The terminal 100 in the present embodiment has a function of a car navigation system. Such the terminal 100 may be configured by combining a car navigation system and a DCM (Data Communication Module) installed in the vehicle 10. The terminal 100 may be a terminal in which an application program for car navigation is installed and which may be a portable terminal that the user can carry into the car (for example, a smartphone or a tablet terminal, etc.). Furthermore, the vehicle 10 in the present embodiment is a BEV (Battery Electric Vehicle) or a PHEV (Plug-in Hybrid Electric Vehicle), and is equipped with a battery that is charged using an external power source.

As illustrated in FIG. 1, the terminal 100 in the present embodiment is configured to include controller 101, storage unit 102, an input/output device 103, location acquisition unit 104, and communication I/F 105.

The controller 101 executes dedicated programs stored in the storage unit 102 to realize various functions, which will be described later. As an example, the controller 101 includes a hardware processor such as a CPU or a GPU. The controller 101 may further include a RAM, a ROM, a cache memory, and the like. In addition, some or all of the functions of the terminal 100 may be realized by a hardware circuit such as an ASIC or an FPGA.

The storage unit 102 includes the auxiliary memory and stores various types of information. The storage unit 102 may be a storage area constructed in the auxiliary memory. The information stored in the storage unit 102 includes, in addition to the OS, an application program for car navigation (hereinafter, sometimes referred to as a “navigation app”), map data used by the navigation application, and the like.

The input/output device 103 receives input operations by the user of the vehicle and presents information to the user. The input/output device 103 includes input devices such as a touch panel or push buttons that can input characters and other symbols and a microphone that can input voice. Furthermore, the input/output device 103 includes output devices such as a display or a speaker. In one example, the input/output device 103 may include a touch panel display, a microphone, and a speaker.

The location acquisition unit 104 detects the current location of the terminal 100 (the current location of the vehicle 10). In one example, the location acquisition unit 104 may be configured to include a Global Positioning System (GPS) receiver that detects the geographic coordinates (e.g., latitude and longitude) of the current location of the vehicle 10. In another example, the location acquisition unit 104 may be configured to include a wireless communication circuit that detects the geographic coordinates or address of the current location o the vehicle 10 using a Wi-Fi (registered trademark) location information service.

The communication I/F 105 includes a communication interface for connecting the terminal 100 to the communication network N1. In one example, the communication I/F 105 may include a communication interface for mobile communications (e.g., 3G, LTE, 5G, 6G, etc.). The communication I/F 105 of the present embodiment communicates with the server 200 through a communication network N1.

In the terminal 100 configured as described above, when a scheduled travel route for the vehicle 10 is set through execution of a navigation app, the controller 101 transmits a route information including the set scheduled travel route to the server 200 via communication I/F 105. In one example, the route information in the present embodiment may be an information in which the identifiers of one or more road links (hereinafter sometimes referred to as “link IDs”) included in the scheduled travel route are arranged in order from the departure point toward the destination. When the communication I/F 105 receives a first command signal or a second command signal transmitted from the server 200 in response to the route information, the controller 101 executes processing according to the first command signal or the second command signal. The first command signal and the second command signal will be described in detail later.

Furthermore, in the terminal 100 configured as described above, while the vehicle 10 is in operation (the ignition switch or power switch is in ON state), the controller 101 transmits a vehicle information including the current location and remaining battery charge of the vehicle 10 to the server via 200 communication I/F 105 at a predetermined period.

The current location of the vehicle 1 included in the vehicle information may be the current location detected by the controller 101 via the location acquisition unit 104. The remaining battery charge included in the vehicle information may be a state of charge (SOC) calculated using a known method such an as OCV method or a current integration method. The calculation of the soc may be performed by the controller 101 or by an ECU (Electronic Control Unit) mounted on the vehicle 10. The SOC calculated by the ECU may be transmitted from the ECU to the terminal 100 via an in-vehicle network such as a CAN (Controller Area Network). When the current location and the remaining battery charge included in the vehicle information satisfy a predetermined condition described later, a first command signal or a second command signal transmitted from the server 200 to the terminal 100 in response to the vehicle information. When such the first command signal or the second command signal is received by the communication I/F 105, the controller 101 executes processing according to the first command signal or the second command signal. In this case, the first command signal and the second command signal are commands having different command contents from the first command signal and the second command signal transmitted from the server 200 in response to the route information, and will be described in detail later.

Next, the configuration of the server 200 will be described. The server 200 of the present embodiment is one or more computers operated by a service provider that notifies the user of the vehicle 10 of the road construction information and the vacancy information of the charging facility. The server 200 of the present embodiment corresponds to “information an processing apparatus” according to the present disclosure. The server 200 is configured as a computer having a processor (such as a CPU or a GPU), main memory (such as a RAM and a ROM), and auxiliary memory (such as an EPROM, a hard disk drive, and a removable medium).

As illustrated in FIG. 1, the server 200 in the present embodiment includes a controller 201, a storage unit 202, a communication I/F 203, and the like.

The controller 201, the storage unit 202, and the communication I/F 203 of the server 200 are similar to the controller 101, the storage unit 102, and the communication I/F 105 of the terminal 100, respectively. However, in addition to programs such as an OS, databases such as a road DB 220 and a charging facility DB 221 are constructed in the storage unit 202 of the server 200. These databases are relational databases constructed in the storage unit 202 by the processor of the server 200 executing a DBMS (Database Management System) program. In addition, the communication I/F 203 of the server 200 may be connected to the network N1 via a LAN or a Wi-Fi (registered trademark).

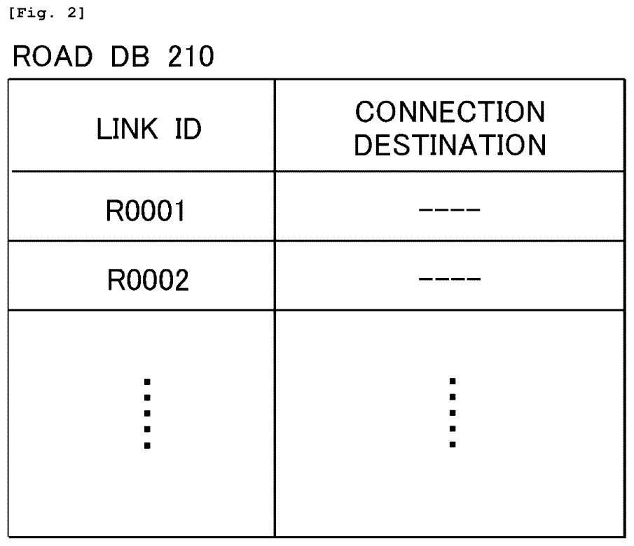

FIG. 2 is a diagram illustrating an example of data stored in the road DB 220. The road DB 220 in the present embodiment has a plurality of records for each road link, as illustrated in FIG. 2. The road links used in the road DB 220 may be the same as those used when setting the scheduled travel route in the car navigation system of the vehicle 10. Each record in the road DB 220 has a link ID field, a connection destination field, and the like. The structure of the records held in the road DB 220 is not limited to the example illustrated in FIG. 2, and fields can be modified, added, or omitted as depending appropriate on the implementation and etc.

In the link ID field of the road DB 220, identifiers of each of a plurality of road links are registered. The identifier registered in the link ID field may be the same as the link ID used in the route information transmitted from the terminal 100 to the server 200. The connection destination field of the road DB 220 stores information about the connection destination of a web page on which the construction information for each road link is posted. The information registered in the connection destination field of the road DB 220 may be, for example, a URI (Uniform Resource Identifier) of the web page on which the construction information for each road link is posted.

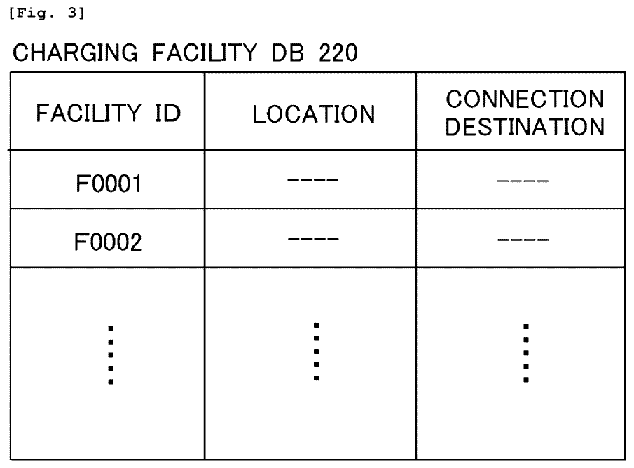

Next, the charging facility DB 221 will be described. FIG. 3 is a diagram illustrating an example of data stored in the charging facility DB 221. As illustrated in FIG. 3, the charging facility DB 221 in the present embodiment has a plurality of records for each charging facility. A charging facility is a facility (charging spot) where an external power source is installed for charging batteries of BEVs, PHEVs, and the like. Each record in the charging facility DB 221 has fields such as a facility ID field, a location field, and connection a destination field. The configuration of the records held in the charging facility DB 221 is not limited to the example illustrated in FIG. 3, and fields can be changed, added, or omitted as appropriate depending on the embodiment.

In the facility ID field of the charging facility DB 221, identifiers (facility IDs) of each of a plurality of charging facilities are registered. In the location field of the charging facility DB 221, the geographical coordinates (for example, latitude and longitude) of the location of each facility are registered. In the connection destination field of the charging facility DB 221, an information regarding a connection destination of a web page on which a vacancy information of each charging facility is posted is registered. The information registered in the connection destination field of the charging facility DB 221 may be, for example, a URI of the web page on which vacancy information of each charging facility is posted. The vacancy information of the charging facility is an information that indicates the vacancy state of the charging facility. The vacancy status of the charging facility may refer to whether or not a charging space (a parking space for connecting vehicle 10 to an external power source) is vacancy, or whether or not the external power source installed at the charging facility is in use.

In the server 200 configured as described above, the controller 201 executes a notification process regarding the road construction on the scheduled travel route by triggering the communication I/F 203 receiving the route information transmitted from the terminal 100. Furthermore, in the server 200 in the present embodiment, the controller 201 executes a notification process regarding the vacancy state of the charging facility by triggering the communication I/F 203 receiving the vehicle information transmitted from the terminal 100. The notification process regarding the road construction on the scheduled travel route and the notification process regarding the vacancy state of the charging facility will be described in detail later.

(Processing flow)

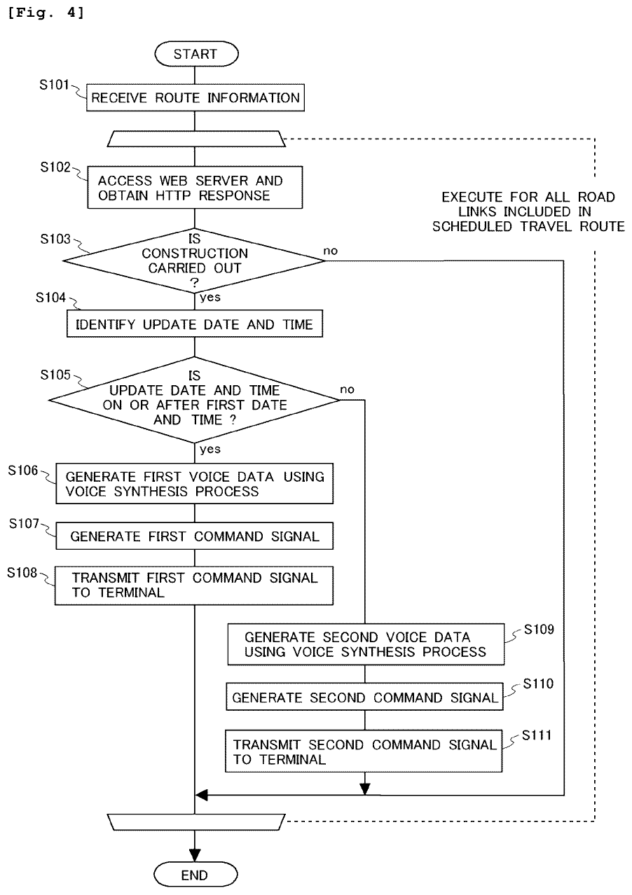

Here, the flow of the notification processing regarding the road construction on the scheduled travel route will be described with reference to FIG. 4. FIG. 4 is a flowchart illustrating n example of a first processing routine executed by the server 200, by triggering the server 200 receiving the route information transmitted from the terminal 100.

In the first processing routine of FIG. 4, the controller 201 of 41 the server 200 receives the route information transmitted from the terminal 100 via communication I/F 203 (step S101). After completing the process of step S101, the controller 201 executes the processes of steps S102 to S111. The processes of steps S102 to S111 is executed for each of one or more road links included in the route information.

In step S102, the controller 201 accesses the road DB 220 in the storage unit 202 using as an argument the link ID of a target road link among the identifiers (link IDs) of one or more road links included in the route information. The controller 201 identifies a record corresponding to the link ID of the target road link. The controller 201 extracts the URI registered in the connection destination field of the identified record. The controller 201 accesses the URI through HTTP communication to obtain a HTTP response from a Web server (a Web server that provides a Web page on which the construction information for the target road link is posted). After completing the process of step S102, the controller 201 executes a process of step S103.

In step S103, the controller 201 analyzes the construction information posted on the web page accessed in step S102 using an existing language model such as LLM (Large Language Models), thereby determining whether construction is being carried out on the target road link. In a case where it is determined that construction is not being carried out on the target road link (negative determination in step S102), the controller 201 executes processing from step S102 onwards on other road links included in the route information (road links that have not yet been the target of execution of steps S102-S111). In a case where it is determined that construction is being carried out on the target road link (positive determination in step S102), the controller 201 executes the process of step S104.

In step S104, the controller 201 identifies the most recent update date and time of the web page on which the construction information for the target road link is posted, according to the information registered in the Last-Modified field included in the header of the HTTP response obtained in step S102. After completing the process of step S104, the controller 201 executes a process of step S105.

In step S105, the controller 201 determines whether the latest update date and time identified in step S104 is on or after the first date and time. The first date and time may be, in one example, a date and time several hours prior to the present time. In another example, the first date and time may be a date and time one day prior to the present time. Such a first date and time is an example of a “predetermined date and time” according to the present disclosure. In a case where it is determined that the latest update date and time identified in step S104 is on or after the first date and time (positive determination in step S105), the controller 201 executes the processes of steps S106 to S108.

In step S106, the controller 201 generates a first voice data based on the construction information posted on the web page accessed in step S102. The first voice data in the processing routine of FIG. 4 includes a voice data obtained by converting a summary of the construction information into voice, and a voice data prompting an operation of a banner. The process of converting the summary of the construction information into voice may be performed by a method of executing a voice synthesis process using an existing summarization function and a TTS (Text To Speech) function. The banner in the processing routine of FIG. 4 is GUI component that is displayed on the screen of the terminal 100 when the first voice data is output by the terminal 100. The GUI component is a GUI component that includes a link information of the Web page on which the construction information is posted. After completing the process of step S106, the controller 201 executes a process of step S107.

In step S107, the controller 201 generates a first command signal. The first command signal is a signal including a command to output the first voice data generated in step S106 as voice and a command to display the above-mentioned banner on the screen. After completing the process of step S107, the controller 201 executes a process of step S108.

In step S108, the controller 201 transmit the first command signal generated in step S107 to the terminal 100 via the communication I/F 203. When the controller 201 has completed executing the process of step S108, the controller 201 executes the processes from step S102 onwards for other road links included in the route information (road links that have not yet been target of execution of steps S102-S111). When the processes of steps S102-S111 have been executed for each of all road links included in the route information, the controller 201 ends the execution of the first processing routine of FIG. 4.

Here, in the terminal 100 that receives the first command signal transmitted from the server 200, the controller 101, in accordance with the first command signal, causes the input/output device 103 to output the first voice data as voice and also causes the input/output device 103 to display a banner on the screen. Then, when the user operates (e.g., taps) the banner displayed on the screen, the controller 101 displays on the input/output device 103 the web page associated with the banner (the web page containing the construction information that was the target of the first voice data).

Furthermore, in step S105, if it is determined that the latest update date and time identified in S104 is earlier than the first date and time (a negative determination in step S105), the controller 201 executes the processes of steps S109 to S111.

In step S109, the controller 201 generates a second voice data based on the construction information posted on the web page accessed in step S102. The second voice data in the processing routine of FIG. 4 includes only voice data obtained by converting the summary of the construction information into voice. The process of converting the summary of the construction information into voice may be performed by a method of executing a voice synthesis process using an existing summarization function and TTS function, similar to the case of generating the first voice data. After completing the process of step S109, the controller 201 executes a process of step S110.

In step S110, the controller 201 generates a second command signal. The second command signal includes only a command to output the second voice data generated in step S109 as voice. After completing the process of step S110, the controller 201 executes a process of step S111.

In step S111, the controller 201 transmit the second command signal generated in step S110 to the terminal 100 via the communication I/F 203. When the controller 201 has completed executing the process of step S111, the controller 201 executes the processes from step S102 onwards for the other road links included in the route information (road links that have not yet been target of the execution of steps S102-S111). When the processes of steps S102-S111 have been executed for each of all road links included in the route information, the controller 201 ends the execution of the first processing routine of FIG. 4.

Here, in the terminal 100 that received the second command signal transmitted from the server 200, the controller 101 causes the input/output device 103 to output the second voice data as voice in accordance with the second command signal.

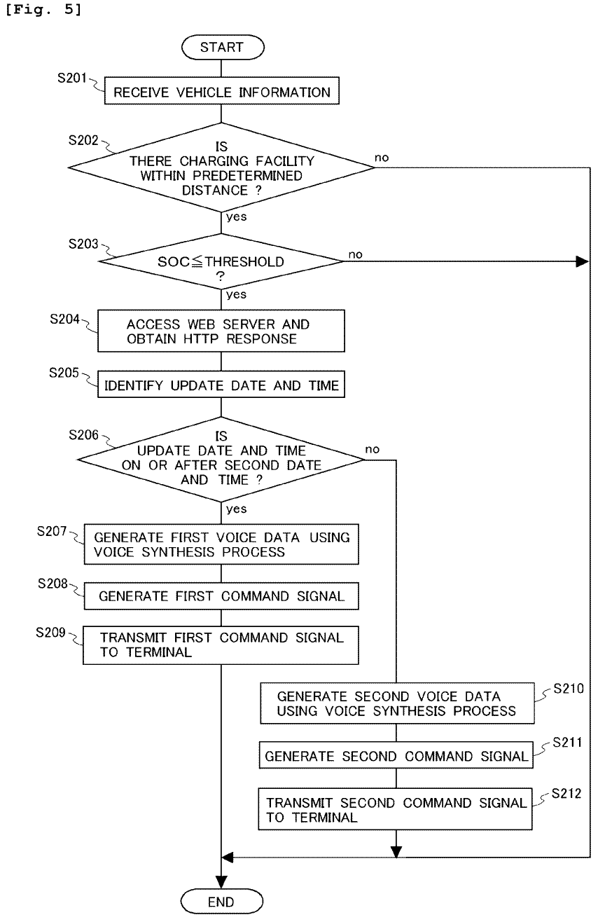

Next, the flow of the notification process regarding the vacancy state of the charging facility will be described with reference to FIG. 5. FIG. 5 is a flowchart illustrating an example of a second processing routine that is executed by the server 200, by triggering the server receiving the vehicle information is received.

In the second processing routine of FIG. 5, the controller 201 of the server 200 receives the vehicle information transmitted from the terminal 100 through communication I/F 203 (step S201). After completing the process of step S201, the controller 201 executes a process of step S202.

In step S202, the controller 201 determines whether there is a charging facility within a predetermined distance (for example, several kilometers) from the current location of the vehicle 10. In detail, the controller 201 identifies an area within a predetermined distance from the current location of the vehicle 10 included in the vehicle information. The controller 201 accesses the charging facility DB 221 in the storage unit 202 and determines whether there is a charging facility whose location registered in the location field is included in the above area. At this time, among the charging facilities whose locations are included in the above-mentioned area, charging facilities located in the opposite direction to travelling direction of the vehicle 10 may be excluded. When there is no charging facility whose location is included in the above area (a negative determination in step S202), the controller 201 ends the execution of the second processing routine in FIG. 5. On the other hand, when there is a charging facility whose location is included in the above area (positive determination in step S202), the controller 201 executes the process of step S203.

In step S203, the controller 201 determines whether the remaining battery charge (SOC) included in the vehicle information is not larger than a threshold (for example, about 50%). In a case where the remaining battery charge is larger than the threshold (negative determination in step S203), the controller 201 ends the execution of the second processing routine in FIG. 5. On the other hand, in a case where the remaining battery charge is not larger than the (positive determination in step S203), the threshold controller 201 determines that a predetermined condition is satisfied. That is, the predetermined condition in present embodiment includes that a charging facility is present within a predetermined distance from the current location of the vehicle 10, and that the remaining battery charge of the vehicle 10 is not larger the threshold. In a case where it is determined that the predetermined condition is met, the controller 201 executes the process of step S204.

In step S204, the controller 201 extracts the URI registered in the connection destination field of the charging facility 221 DB for the charging facility (hereinafter, sometimes referred to as the “target charging facility”) that was determined in step S202 to be within a predetermined distance from the current location of the vehicle 10. The controller 201 accesses the URI through HTTP communication to obtain an HTTP response from a web server (a web server that provides a web page on which a vacancy information of the target charging facility is posted). After completing the process of step S204, the controller 201 executes a process of step S205.

In step S205, the controller 201 identifies the latest update date and time of the web page on which the vacancy information of the target charging facility is posted, based on the information registered in the Last-Modified included in the HTTP response obtained in step S204. After completing the process of step S205, the controller 201 executes a process of step S206.

In step S206, the controller 201 determines whether the latest update date and time identified in step S205 is on or after the second date and time. The second date and time may be, for example, a date and time several tens of minutes or several hours before the current time. In another example, the second date and time may be one hour prior to the current time. Such the second date and time is another example of a “predetermined date and time” according to the present disclosure. In a case where it is determined that the latest update date and time identified in step S205 is on or after the second date and time (positive determination in step S206), the controller 201 executes the process of steps S207 to S209.

In step S207, the controller 201 generates a first voice data based on the vacancy information posted on the web page accessed in step S204. The first voice data in the processing routine of FIG. 5 includes a voice data obtained by converting a summary of the vacancy information into voice and voice data prompting an operation of a banner. The process of converting the summary of the vacancy information into voice may be performed by a method of executing a voice synthesis process using an existing summarization function and a TTS (Text To Speech) function. Moreover, the banner in the processing routine of FIG. 5 is GUI component that is displayed on the screen of the terminal 100 when the first voice data is output by the terminal 100. The GUI component includes a link information for the web page on which the vacancy information is posted. After completing the process of step S207, the controller 201 executes a process of step S208.

In step S208, the controller 201 generates a first command signal. The first command signal is a signal including a command to output the first voice data generated in step S207 as voice and a command to display the above-mentioned banner on the screen. After completing the process of step S208, the controller 201 executes a process of step S209.

In step S209, the controller 201 transmit the first command signal generated in step S208 to the terminal 100 via the communication I/F 203. After completing the process of step S209, the controller 201 ends the execution of the second processing routine of FIG. 5.

Here, in the terminal 100 that receives the second command signal transmitted from the server 200, the controller 101 causes, in accordance with the second command signal, the input/output device 103 to output the first voice data as voice and also to display a banner on the screen. Then, when the user operates the banner displayed on the screen, the controller 101 displays the web page associated with the banner (the web page on which the vacancy information being target of the first voice data is posted) on the input/output device 103.

Furthermore, in a case where it is determined in step S206 that the latest update date and time identified in S205 is earlier than the second date and time (negative determination in step S205), the controller 201 executes the processes of steps S210 to S212.

In step S210, the controller 201 generates a second voice data based on the vacancy information posted on the web page accessed in step S204. The second voice data in the processing routine of FIG. 5 includes only voice data obtained by converting the summary of the vacancy information into voice. The process of converting the summary of the vacancy information into voice may be performed by a method of executing a voice synthesis process using an existing summarization function and TTS function, similar to the case of generating the first voice data. After completing the process of step S210, the controller 201 executes a process of step S211.

In step S211, the controller 201 generates a second command signal. The second command signal includes only a command to output the second voice data generated in step S210 as voice. After completing the process of step S211, the controller 201 executes a process of step S212.

In step S212, the controller 201 transmit the second command signal generated in step S211 to the terminal 100 via the communication I/F 203. After completing the process of step S212, the controller 201 ends the execution of the second processing routine of FIG. 5.

Here, in the terminal 100 that received the second command signal transmitted from the server 200, the controller 101 causes the input/output device 103 to output the second voice data as voice in accordance with the second command signal.

### Operation and Advantageous Effects of the Embodiments

In the embodiment described above, when notifying the user of the road construction information and the vacancy information of the charging facility, the user of the vehicle 10 can be notified using different voices depending on whether the update date and time is new or old. This allows the user of the vehicle 10 to distinguish whether the update dates and times of the notified road construction information and the vacancy information are new or old. In addition, when the update date and time is old, the notification is given by voice data with a shorter sentence than when the update date and time is new, so that the user can be prevented from feeling annoyed. Furthermore, by notifying the user of the road construction information and the vacancy information by voice, it is possible to prevent the user from staring at the display screen of the terminal 100 while driving.

Therefore, according to the present embodiment, it is possible to improve the convenience for the user when providing information to the user of the vehicle 10.

### OTHERS

The above-described embodiment is merely an example, and the present disclosure can be modified and implemented as appropriate without departing from the scope of the present disclosure. For example, among the functions of the server 200, the function of generating the first voice data and the second voice data may be realized by the terminal 100.

The technology disclosed herein can be implemented by supplying a computer program (information processing program) or programs configured to implement the functions described in the above description of the embodiments to a computer to cause one or more processors of the computer to read out and execute the program or programs. Such the computer program or programs may be supplied to the computer by a non-transitory, computer-readable storage medium that can be connected to a system bus of the computer or through a network.

What is claimed is:

1. An information processing apparatus comprising a controller configured to execute processing of:
obtaining a HTTP (Hyper Text Transfer Protocol) response by accessing a web page on which a notification information that is an information to be notified to a user of a vehicle is posted;
identifying a latest update date and time of the notification information according to a Last-Modified included in a header of the HTTP response;
determining whether the identified update date and time is on or after a predetermined date and time;
in a case where it is determined that the update date and time is on or after the predetermined date and time, generating a first voice data including a voice data obtained by converting the notification information posted on the web page using an existing voice synthesis process and predetermined voice data, and transmitting a first command signal to output the first voice date to a terminal mounted on the vehicle; and
in a case where it is determined that the update date and time is earlier than the predetermined date and time, generating a second voice data including only the voice data obtained by converting the notification information posted on the web page using the existing voice synthesis process, and transmitting a second command signal to output the second voice data to the terminal.

2. An information processing apparatus comprising a controller configured to execute processing of:
accessing a web page on which a notification information that is an information to be notified to a user of a vehicle is posted;
obtaining a latest update date and time of the notification information posted on the web page;
determining whether the obtained update date and time is on or after a predetermined date and time;
in a case where it is determined that the update date and time is on or after the predetermined date and time, transmitting a first command to output first voice data that is a voice data according to the notification information posted on the web page to a terminal mounted on the vehicle; and
in a case where it is determined that the update date and time is earlier than the predetermined date and time, transmitting a second command to output a second voice data that is a voice according to the notification information posted on the web page and that is having a shorter sentence than the first voice data to the terminal.

3. The information processing apparatus according to the claim 2, wherein
the first command, in addition to a command to output of the first voice data, further includes a command to output a GUI (Graphical User Interface) components including a link information of the web page,
the first voice data includes a voice data obtained by converting the notification information using an existing voice synthesis process and a voice data that prompts an operation of the GUI component,
the second command includes only a command to output the second voice data,
the second voice data including only a voice data obtained by converting the notification information posted on the web page using the existing voice synthesis process.

4. The information processing apparatus according to the claim 3, wherein
the notification information is a construction information regarding a road construction,
the controller configured to execute processing of:
receive a scheduled travel route of the vehicle from the terminal;
in response to receiving the scheduled travel route, accessing a web page on which a construction information of a road included in the scheduled travel route is posted;
obtaining a latest update date and time of the construction information posted on the web page;
determining whether the obtained update date and time is on or after the predetermined date and time;
in a case where it is determined that the update date and time is on or after the predetermined date and time, transmitting the first command to the terminal; and
in a case where it is determined that the update date and time is earlier than the predetermined date and time, transmitting the second command to the terminal.

5. The information processing apparatus according to the claim 3, wherein
the notification information is a vacancy information regarding the vacancy status of a charging facilities for a vehicle battery,
the controller configured to execute processing of:
periodically receiving a current location and a remaining battery charge of the vehicle from the terminal;
each time the current location and the remaining battery charge of the vehicle are received, determining whether a predetermined condition is met, which includes that the distance between the current location and the charging facility is not longer than a predetermined distance and that the remaining battery charge is not larger than a threshold;
in response to the determination that the predetermined condition is satisfied, accessing the web page on which the vacancy information of the charging facility is posted;
obtaining the latest update date and time of the vacancy information posted on the web page;
determining whether the obtained update date and time is on or after the predetermined date and time;
in a case where it is determined that the update date and time is on or after the predetermined date and time, transmitting the first command to the terminal; and
in a case where it is determined that the update date and time is earlier than the predetermined date and time, transmitting the second command to the terminal.
